(19) United States
(12) Patent Application Publication
(10) Pub. No.: US 2004/0069327 A1
(43) Pub. Date: Apr. 15, 2004

(54) Shaping and cleaning of gel-forming biopolymers

(76) Inventors: Wilhelm Hinsen, Ratingen (DE); Gunter Hofmann, Duisburg (DE)

Correspondence Address: CANTOR COLBURN LLP, 55 Griffin Road South, Bloomfield, CT, 06002, US

(21) Appl. No.: 10/679,889

(22) Filed: Oct. 6, 2003

(30) Foreign Application Priority Data
Oct. 9, 2002 (DE) 102 47 157.6

(51) Int. Cl. B08B 3/14; C11D 17/00

(52) U.S. Cl. 134/42

(57) ABSTRACT

The present invention relates to a method for cleaning a biopolymer, which exists after extensive removal of the organic solvent used for extraction from the biomass by means of a steam distillation process in the form of granules. Through the novel cleaning method, the contaminants remaining in the granules of the extracted bio-polymer as well as solvent residues are to be depleted quickly, easily and inexpensively, whereby according to the invention, this is accomplished in that granules with a content of less than 25% by weight of organic solvents are treated at least once with an organic cleaning solution that cannot be randomly mixed with water such that through the displacement of the aqueous phase by means of the cleaning solution, the water-soluble contaminants [are depleted], and through elution of the contaminants that are soluble in the organic solvent in the cleaning solution, a depletion of the contaminants of the granules is brought about, whereby subsequently the aqueous phase is separated and the cleaned granules are separated from the cleaning solution.

The present invention relates to a method for cleaning polyhydroxyalkanoates (PHA), e.g. polyhydroxy-β-butyric acid (PHB), which exist in the form of porous granules after (extensive) removal of the organic solvent that is used for extraction from the biomass by means of a steam distillation process.

The Brazil patent PI 9302312 describes a method according to which polyhydroxyalkanoates can be obtained from a biomass through hot extraction with isoamyl alcohol. Said mass is previously produced with a suitable fermentation method and is largely separated from the fermentation broth before being placed in the extraction. The extracted biomass is separated from the hot extraction solution e.g. through filtration. The polyhydroxyalkanoates are insoluble at low temperatures in the organic solvent after the extraction solution has cooled off. A concentration of the polymers e.g. through filtration, centrifugation or similar procedures is thus possible within certain limits. For complete separation of the isoamyl alcohol from the polyhydroxyalkanoates, it must be removed through treatment of the PHB/solvent suspension e.g. by means of steam or boiling water.

A particularly economical way of evaporation of organic solvents that can be mixed with water only conditionally (e.g. isoamyl alcohol) by means of a continuous multi-stage evaporation process is described in the application for patent DE 101 28 663.5.

Evaporation of the solvent takes place with a composition of the liquid phase within the miscibility gap of the solvent with water. The bio-polymer that has been suspended in an organic solvent (e.g. IAA) is fed into the evaporators of a multi-stage evaporation plant with a suitable amount of water. The evaporators are heated indirectly with steam or the exhaust vapors of the preceding stage, which was operated at a higher boiling temperature. The precipitating exhaust vapors disintegrate into an aqueous phase and an organic phase, which are saturated with the other solvent, respectively. The aqueous phase is preferably recycled into the evaporators for supplementing the loss of water incurred during evaporation. The organic condensate is available again as extraction agent upon expulsion of water.

During such an evaporation process, the biopolymer forms granules, which are gel-like at a high solvent content and relatively hard and inherently stable at a lower solvent content. The liquid content of the granules can—depending on the conditions of the steam distillation process—amount up to more than 85% in both cases. The liquid that is trapped in the granules contains organic and inorganic contaminants, which were eluted jointly with the biopolymer during extraction of the biomass. They have to be removed largely before the bio-polymer is used for resin production.

When cleaning the granules with water, essentially only water-soluble components are removed. Granules rich in isoamyl alcohol already dissolve very quickly when mixed with even small amounts of isoamyl alcohol or other organic solvents and form a gel, which contains the majority of the originally existing organic contaminants. This means that cleaning with organic solvents for the purpose of removing water insoluble contaminants is not possible in this case.

Surprisingly it was found that during steam distillation granules that are depleted of isoamyl alcohol can be mixed with any random excess amount of isoamyl alcohol or another solvent that cannot be mixed randomly with water, in which polyhydroxyalkanoates are not soluble (e.g. ethyl acetate), without leading to gel formation. Rather, this leads to only a slight swelling of the granules (when using isoamyl alcohol) or also to a disintegration of the granules (when using ethyl acetate) into smaller particles and to an almost complete displacement of the aqueous phase contained in the granules by the organic solvent. Gel formation does not occur even when the granules (e.g. also due to the effect of shearing forces caused by a stirrer) disintegrate into smaller particles, which can likewise be filtered easily.

The aqueous phase with the contaminants contained therein separates due to the higher density and can be cleaved. The granules containing the organic solvent remain in the organic phase, but sediment there. The organic contaminants contained in the interior of the granules can turn into the organic cleaning solution and can thus be eluted. By applying a counter-current cleaning process on the granules, these contaminants can be depleted by nearly any random factor. The cleaning process of the granules with the organic solvent consequently causes depletion of contaminants that are soluble preferably in water and also those preferably soluble in the organic solvent.

Upon separation of the cleaning liquid from the granules, the granules can be freed from the residue of the organic cleaning solution contained in the interior through steam distillation or from the solvent when using an easily volatile solvent such as ethyl acetate also directly in a dryer.

Embodiments:

1. Cleaning of granules made of polyhydroxyalkanoates especially of polyhydroxy-β-butyric acid and its co-polymers with other polyhydroxyalkanoates, which previously were freed largely from the extracting agent isoamyl alcohol by means of a steam distillation process and in which the isoamyl alcohol content of the granules is below 25% by weight and preferably below 10% by weight, preferably through the renewed addition of isoamyl alcohol as cleaning liquid, wherein the aqueous phase contained in the granules is largely expelled by isoamyl alcohol, and hence water insoluble contaminants contained in the granules can be eluted with isoamyl alcohol. The subsequent separation of the cleaning solution loaded with contaminants occurs by means of suitable filters, centrifuges or similar dehydration units.

2. Cleaning of granules made of polyhydroxyalkanoates especially of polyhydroxy-β-butyric acid and its co-polymers with other polyhydroxyalkanoates, which previously were freed largely from the extracting agent isoamyl alcohol by means of a steam distillation process, in accordance with example 1, however while using another organic solvent that cannot randomly be mixed with water without solubility properties for PHB such as ethyl acetate. The subsequent separation of the cleaning solution loaded with contaminants occurs by means of suitable filters, centrifuges or similar dehydration units.

3. Cleaning of granules made of polyhydroxyalkanoates especially of polyhydroxy-β-butyric acid and its co-polymers with other polyhydroxyalkanoates, which previously were largely freed from the extracting agent isoamyl alcohol by means of a steam distillation process, pursuant to example 1 or 2, whereby the organic cleaning fluid employed is saturated with water, and beyond that additional water can also be introduced in the cleaning process.

4. Cleaning of granules made of polyhydroxyalkanoates, especially of polyhydroxy-β-butyric acid and its co-polymers with other polyhydroxyalkanoates, which previously were largely freed from the extracting agent isoamyl alcohol by means of a steam distillation process, pursuant to examples 1 through 3, wherein the cleaning process is conducted one time, or several times successively after respective separation of the cleaned granules from the organic cleaning solution and the separated aqueous phase multiple times, or the cleaning process occurs in a washing tower in which the organic cleaning solution is directed in a counter-current to the granules.

5. Cleaning of granules made of polyhydroxyalkanoates especially of polyhydroxy-β-butyric acid and its co-polymers with other polyhydroxyalkanoates, which previously were largely freed from the extracting agent isoamyl alcohol by means of a steam distillation process, pursuant to examples 1 through 4, whereby during a multiple cleaning process or before addition of the granules in a washing tower initially the aqueous phase is separated, which is precipitated during the first mixture of the granules with the organic cleaning medium.

1. Method for cleaning a bio-polymer, which exists in the form of porous granules after extensive removal of the organic solvent used for extraction from the biomass by means of a steam distillation process,
characterized in that
the granules with a content of less than 25% by weight of organic solvent are treated at least once with an organic cleaning solution that cannot be randomly mixed with water such that through the displacement of the aqueous phase by means of the cleaning solution the water-soluble contaminants and by means of elution of the contaminants in the cleaning solution that are soluble in the organic solvent, a depletion of the contaminants in the granules is affected, wherein subsequently the aqueous phase is separated and the cleaned granules are separated from the cleaning solution.

2. Method according to claim 1, characterized in that the granules with a content of less than 10% by weight of an organic solvent are treated at least once with the organic cleaning solution.

3. Method according to claims 1 and 2, characterized in that preferably inherently stable granules are treated.

4. Method according to one of claims 1 through 3, characterized in that the organic solvent used for extraction is isoamyl alcohol.

5. Method according to one of claims 1 through 4, characterized in that the bio-polymer consists preferably of polyhydroxyalkanoates, and in that these are preferably polyhydroxy-β-butyric acid as well as their co-polymers with other polyhydroxyalkanoates.

6. Method according to one of claims 1 through 5, characterized in that an organic solvent without any or with poor solubility properties is used as the cleaning solution for the biopolymer.

7. Method according to one of claims 1 through 6, characterized in that isoamyl alcohol or another organic solvent that can likewise not be randomly mixed with water is used as the cleaning solution.

8. Method according to one of claims 1 through 7, characterized in that isoamyl alcohol or ethyl acetate are used as the cleaning solution.

9. Method according to one of claims 1 through 8, characterized in that the cleaning solution is saturated with water.

10. Method according to one of claims 1 through 9, characterized in that additional water is introduced into the process.

11. Method according to one of claims 1 through 10, characterized in that the separation of the cleaning solution that is loaded with the contaminants occurs by means of gravity precipitation or through suitable filters, centrifuges and/or similar dehydration units.

12. Method according to one of claims 1 through 11, characterized in that, for the purpose of multiple cleaning, the cleaned granules are mixed again with an organic cleaning solution after the respective separation of the cleaning solution that is loaded with the contaminants and are cleaned again.

13. Method according to one of claims 1 through 11, characterized in that, during multiple cleaning, the granules and the cleaning solution are directed in a countercurrent.

14. Method according to one of claims 1 through 11 and according to claim 13, characterized in that this counter-current cleaning of the granules is conducted in a washing tower.

15. Method according to one of claims 1 through 14, characterized in that the aqueous solution that was precipitated at the beginning from the granules is separated before execution of the subsequent cleaning steps.
